(19) United States
(12) Patent Application Publication
(10) Pub. No.: US 2003/0201892 A1
(43) Pub. Date: Oct. 30, 2003

(54) Alarm system for AC condenser coil unit

(76) Inventors: Mickey T. Chance, Benton, LA (US); Leonard K. Koglin, Bossier City, LA (US)

Correspondence Address: R. Keith Harrison, 2139 E. Bert Kouns, Shreveport, LA, 71105, US

(21) Appl. No.: 10/094,388

(22) Filed: Mar. 8, 2002

(51) Int. Cl. G08B 13/12

(52) U.S. Cl. 340/568.2

(57) ABSTRACT

An alarm system which is particularly adaptable for deterring theft of condenser coils from the outside condenser unit of a home or business air conditioning system. The alarm system of the present invention includes an alarm monitor circuit which is connected to the condenser coils or to an alarm panel or screen on the housing of the condenser unit, typically using a tethered switch, an alarm clip, magnets, or other suitable attachment mechanism. The alarm monitor circuit is broken and activates an alarm upon partial or complete removal of the condenser coils or upon partial or complete removal of the panel or screen from the condenser unit.

### BACKGROUND OF THE INVENTION

### FIELD OF THE INVENTION

The present invention relates to alarm systems for deterring theft of articles, and more particularly, to an alarm system which is particularly adaptable for deterring theft of a condenser coil unit from the outside condenser unit of a home or business air conditioning system. The alarm system of the present invention includes an alarm monitor circuit which is connected to the condenser coil unit or to a control panel or screen on the compressor housing of the condenser unit typically using a tethered switch, an alarm clip, magnets or other suitable attachment mechanism. The alarm monitor circuit is broken and activates an alarm upon partial or complete unauthorized removal of the condenser coil unit from the condenser unit.

Most home and business air conditioning systems include a “cold side” and a “hot side”. The “cold side” is typically located inside the home or business building and includes the blower and air duct system components for distributing cool air throughout the building. The “hot side” includes a condenser unit having a refrigerant intake conduit for conveying a typically fluorinated hydrocarbon refrigerant such as FREON (trademark) into the unit, a compressor, and a condenser coil unit including a network of metal tubing and heat exchange fins. In operation, the refrigerant enters the compressor in a vaporized state, and the compressor pressurizes the refrigerant and forces it through the condenser coil unit. As a fan in the condenser unit draws outside air across the condenser coil unit, the refrigerant condenses into a liquid form in the tubing and emits heat to the heat exchange fins, and the heat is absorbed by the flowing air. The fan blows the heated air from the condenser unit, and the cooled refrigerant circulates to the “cold side” of the system inside the home or business to continue the cooling process.

The metal tubing and heat exchange fins in the condenser coil units of the condenser unit are typically constructed of copper, aluminum, or both copper and aluminum, which periodically reaches considerable resale values depending on the market for these metals. As a result, the condenser coil units, particularly in the condenser units of small businesses, are frequently the target of thieves who tear the unit open and pry the condenser coil unit loose from the connecting elements of the unit in order to subsequently sell the metal in the unit. As a result, the condenser unit is usually damaged beyond repair and must be replaced at high cost.

A variety of alarm systems are known in the art for deterring theft of articles. Patents of interest in this regard include U.S. Pat. Nos. 3,710,372; 3,794,989; 3,932,857; 4,536,754; 5,089,807; 5,574,430; and 6,285,283.

### SUMMARY OF THE INVENTION

An alarm system for deterring theft of an article. The alarm system of the present invention includes an alarm monitor circuit which is connected to the article typically using a tethered switch, an alarm clip, magnets, or other suitable attachment mechanism. The alarm monitor circuit is broken and activates an alarm upon partial or complete removal of the article.

### BRIEF DESCRIPTION OF THE DRAWINGS

The invention will be better understood by reference to the accompanying drawings, wherein:

FIG. 1 is a perspective view of an air conditioning condenser unit in implementation of the present invention;

FIG. 2 is a sectional view, taken along section lines 2-2 in FIG. 1, of the air conditioning condenser unit;

FIG. 3 is a perspective view, taken along section line 3 in FIG. 2, of a condenser coil unit, in section, of the condenser unit, more particularly illustrating an illustrative embodiment of the present invention;

FIG. 4 is a perspective view, taken along section line 4 in FIG. 2, of the condenser coil unit, in section, more particularly illustrating another illustrative embodiment of the present invention;

FIG. 5 is a perspective view, taken along section line 5 in FIG. 2, of the condenser coil unit, in section, more particularly illustrating yet another illustrative embodiment of the present invention;

FIG. 6 is a perspective view, taken along section line 5 in FIG. 2, of the condenser coil unit, in section, more particularly illustrating breaking of an alarm monitor circuit in the embodiment of the invention illustrated in FIG. 5;

FIG. 7 is a perspective view, taken along section line 7 in FIG. 2, of the condenser coil unit, in section, more particularly illustrating still another embodiment of the present invention;

FIG. 8 is a perspective view of an air conditioning condenser unit in implementation of the present invention;

FIG. 9 is a sectional view, taken along section lines 9-9 in FIG. 8, of the air conditioning condenser unit, more particularly illustrating compression of a spring-loaded button inside a switch contained in the condenser unit by a control panel for maintaining an alarm monitor circuit;

FIG. 10 is a sectional view, taken along section lines 9-9 in FIG. 8, of the air conditioning condenser unit, more particularly illustrating removal of the control panel from the air conditioning condenser unit and extension of the button from the switch to activate an alarm activation circuit; and

FIG. 11 is a perspective view of the condenser coil unit element of an AC condenser unit, illustrating still another embodiment of the present invention.

### DESCRIPTION OF THE EMBODIMENTS

The present invention has particularly beneficial utility in deterring theft of condenser coil units from outside air conditioning condenser units. However, the invention is not so limited in application, and while references may be made to such condenser coil units, the invention is applicable to deterring theft of articles in a variety of applications.

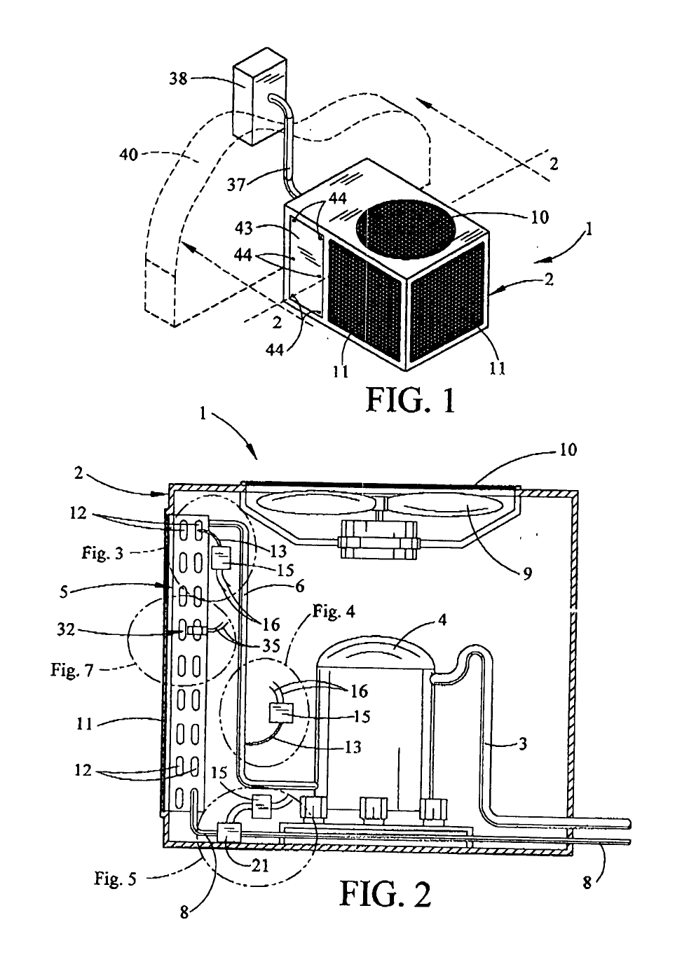

Referring initially to FIGS. 1-3 of the drawings, an AC (air conditioning) condenser unit suitable for implementation of the present invention is generally indicated by reference numeral 1. The conventional AC condenser unit 1 is typically located adjacent to an exterior wall 40 outside of a home or business, as illustrated, or alternativley, on the roof of a home or business and includes a compressor housing 2 fitted with one or multiple housing screens 11. An electric fan 9 is rotatably mounted beneath a fan screen 10 on top of the compressor housing 2, and a condenser coil unit 5 is mounted in the compressor housing 2, adjacent to the housing screen or screens 11. A refrigerant intake conduit 3 leads from outside the compressor housing 2, to the intake of a compressor 4 contained in the compressor housing 2, and a condenser coil conduit 6 connects the output of the compressor 4 to the condenser coil unit 5. A refrigerant output conduit 8 leads from the condenser coil unit 5 to the exterior of the compressor housing 2. In some roof units, the “hot” and “cold” sides of the system are located in a common housing on the roof.

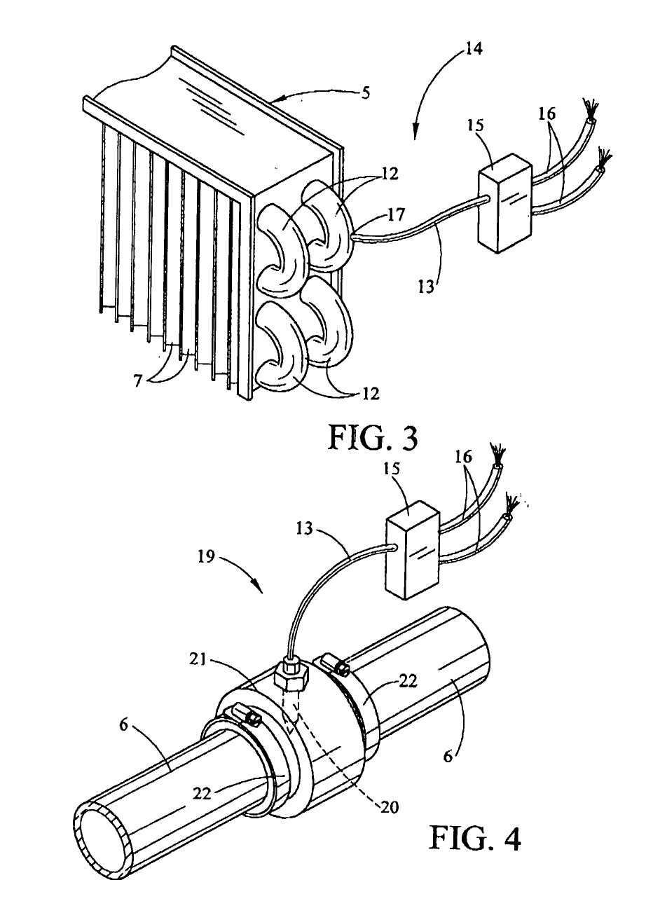

In typical operation of the AC condenser unit 1, the refrigerant intake conduit 3 conveys a refrigerant coolant such as FREON (trademark) first into the compressor housing 2 and then into the compressor 4. As the compressor 4 pressurizes the vaporized refrigerant and forces the refrigerant through multiple condenser coils 12 of the condenser coil unit 5, the refrigerant condenses from gaseous to liquid form to cool and release heat to multiple heat exchange fins 7 (FIG. 3) through which the condenser coils 12 extend. Simultaneously, the fan 9 draws outside air into the compressor housing 2 through the housing screen or screens 11 and across the condenser coils 12 and heat exchange fins 7 of the condenser coil unit 5. The heat released from the compressed refrigerant to the condenser coils 12 and heat exchange fins 7 is subsequently exchanged to the flowing air. The fan 9 expels the heated air from the compressor housing 2 through the fan screen 10, and the cooled liquid refrigerant is conveyed from the compressor housing 2 through a refrigerant output conduit 8. A control panel 43, typically removably secured to the compressor housing 2 by means of screws 44, covers a housing opening 45 (FIG. 10) through which interior components of the AC condenser unit 1 may be accessed, as needed, in conventional fashion.

Because the condenser coils 12 and heat exchange fins 7 of the condenser coil unit 5 are typically constructed of copper, aluminum, or both copper and aluminum, the condenser coil unit 5 is valuable and therefore, a frequent target of thieves. Accordingly, the thieves typically pry the control panel 43 or housing screen or screens 11 off of the compressor housing 2, detach the condenser coil unit 5 from the connecting elements in the compressor housing 2 and remove the condenser coil unit 5 from the compressor housing 2 for sale of the copper, aluminum or copper and aluminum components of the condenser coil unit 5.

Referring again to FIGS. 1-3 of the drawings, in one embodiment of the alarm system of the present invention, generally indicated by reference numeral 14 in FIG. 3, an alarm 38 (FIG. 1), which may include an audio alarm, a visual alarm, or both, is mounted on the inside surface of an exterior wall 40 or in any other suitable location in a home or business. Alternatively, the alarm 38 may be mounted in a weatherproof enclosure (not illustrated) or may be otherwise weatherproofed according to the knowledge of those skilled in the art for mounting on the exterior surface of the exterior wall 40, on the side of the compressor housing 2 or other suitable location outside the home or business or on the interior or exterior of the compressor housing 2. Still further in the alternative, an inside alarm 38 may be provided inside the home or business, in combination with an outside alarm 38 outside the home or business. The alarm 38 may be any type of alarm known by those skilled in the art in which termination of current flow in an alarm monitor circuit activates the alarm 38. Such an alarm typically includes the alarm monitor circuit, which is connected to an alarm activation circuit by means of a relay, such that termination of current flow in the alarm monitor circuit causes the relay to initiate current flow in the alarm activation circuit, and the alarm activation circuit energizes the audio, visual, or both audio and visual alarm components to signal tripping of the alarm 38. The alarm 38 may be the security alarm system of the home or business and powered or energized through a typically 120 volt A/C outlet (not illustrated) in the home or business, through a battery (not illustrated), or through the A/C outlet under normal circumstances and through a battery in the event of power failure, in conventional fashion. Alternatively, the alarm 38 may be powered using any suitable AC or DC power source.

A pair of wiring leads 16 (FIG. 3) of the alarm system 14 forms a part of the alarm monitor circuit and initially extends from the alarm 38 and through the exterior wall 40, typically through a wiring conduit 37, as illustrated in FIG. 1, to weather-proof the wiring leads 16. The wiring leads 16 enter the compressor housing 2 of the AC condenser unit 1 from the wiring conduit 37. The wiring leads 16 are connected to a low pressure switch 15 and form an electrical alarm monitor circuit between the switch 15 and the alarm 38. One end of a tether 13, which is typically constructed of copper connecting tubing but which may be constructed of any other metal or suitable material, is typically connected to one of the condenser coils 12. Alternatively, the tether 13 may be connected to a heat exchange fin 7 or any other element of the condenser coil unit 5. In the case of a copper or other metal tether 13, the tether 13 may be connected to the condenser coil 12 by means of soldering 17. The opposite end of the tether 13 is connected to the interior activating mechanism (not illustrated) of the switch 15. Accordingly, the low pressure switch normally maintains the alarm monitor circuit in a closed position by maintaining electrical contact between the wiring leads 16 inside the switch 15. Upon pulling of the tether 13 against the switch 15, the internal activating mechanism of the switch 15 breaks electrical communication between the wiring leads 16. Consequently, current flow through the alarm monitor circuit defined by the switch 15, the wiring leads 16 and the alarm 38 is terminated, and this activates the alarm activation circuit in the alarm 38.

In operation, the wiring leads 16 complete the electrical alarm monitor circuit between the switch 15 and the alarm 38, and the switch 15 normally maintains the circuit in a closed configuration to enable continuous flow of current through the alarm monitor circuit, as heretofore described. In the event that an unauthorized attempt is made to remove the condenser coil unit 5 from the compressor housing 2, typically through the housing opening 45 (FIG. 10) exposed by removing the control panel 43 from the condenser housing 2, or alternatively, through the air opening or openings normally covered by the housing screen or screens 11, respectively, the tether 13 is pulled taut between the condensor coil unit 5 and the switch 15 and pulls against the internal activating mechanism of the switch 15. Consequently, the switch 15 opens the alarm monitor circuit and terminates current flow therethrough by interrupting electrical communication between the wiring leads 16 inside the switch 15. The termination of current flow in the alarm monitor circuit causes energizing of the alarm activation circuit in the alarm 38, thereby activating the alarm 38. Persons in the home or business are then alerted to the attempted theft of the condenser coil unit 5 and are thus able to notify security personnel. In the event that the alarm 38 is located outside the home or business, typically on the exterior wall 40 or on the compressor housing 2, the activated alarm 38 startles the thief or thieves and usually causes the thief or thieves to discontinue removing the condenser coil unit 5 and flee. Preferably, the pressure switch 15 is set to a very low pressure threshold, such that only a small pulling force of the tether 13 against the switch 15 is necessary to actuate the switch 15 and terminate flow of current through the alarm monitor circuit, thereby activating the alarm 38. In that case, the alarm 38 would be activated in the event that an attempt is made to cut the tether 13 using wire cutters or pliars prior to or during removal of the condensing coil unit 5 from the compressor housing 2.

Referring next to FIG. 4 of the drawings, in another embodiment the alarm system of the present invention is generally indicated by reference numeral 19. One end of the tether 13 is attached typically by means of a self-tapping screw 20 to a clamp collar 21, which may be secured by means of clamp rings 22 to the condenser coil conduit 6 or any other suitable element of the condenser coil unit 5. The clamp collar 21 typically has a hinged or clamp configuration (not illustrated) such that the clamp collar 21 can be easily secured or clamped on the condenser coil unit 6 without the need for cutting and separating adjacent segments of the condenser coil conduit 6. As heretofore described with respect to the embodiment of the invention illustrated in FIG. 3, upon attempted unauthorized removal of the condenser coil unit 5 from the compressor housing 2, the tether 13 pulls against the internal actuating mechanism of the switch 15, which is then actuated to break the alarm monitor circuit between the switch 15 and the alarm 38 by interrupting electrical communication between the wiring leads 16 inside the switch 15, thereby activating the alarm 38 by energizing of the alarm activation circuit. It will be understood that any type of fastener known by those skilled in the art, including bolts or clips (not illustrated), in non-exclusive particular, may be used to attach the tether 13 either directly or by means of the clamp collar 21 to the condenser coil unit 6, the refrigerant output conduit 8 or to any other suitable element of the condenser coil unit 5.

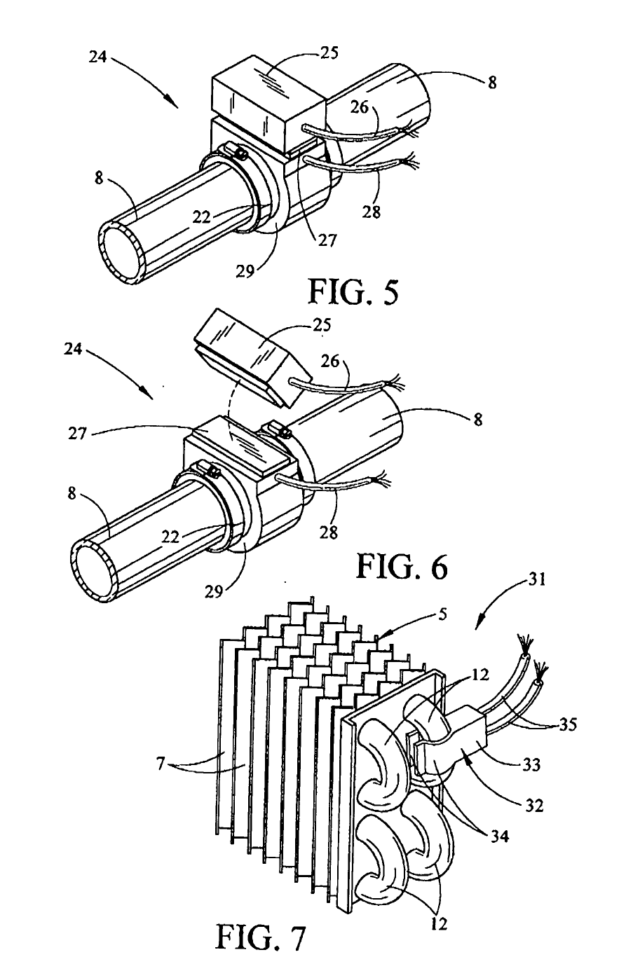

Referring next to FIGS. 5 and 6 of the drawings, in still another embodiment of the alarm system of the present invention, generally indicated by reference numeral 24, a stationary magnet 25 inside the compressor housing 2 is connected to a stationary magnet wiring lead 26 which extends from the compressor housing 2 and to the alarm 38, typically through the wiring conduit 37. The range of movement of the stationary magnet 25 in the compressor housing 2 may be limited by either mounting the stationary magnet 25 on a fixed support (not illustrated) inside the compressor housing 2 or by selecting the length of the stationary magnet wiring lead 26 accordingly. A unit magnet 27, having a magnetic polarity opposite that of the stationary magnet 25, is typically mounted on a magnet clamp 29 which may be attached by means of clamp rings 22 to the refrigerant output conduit 8, as illustrated, to the condenser coil conduit 6, or to any other suitable element of the condenser coil unit 5. The magnet clamp 29 typically has a hinged or clamp configuration (not illustrated) such that the magnet clamp 29 can be easily secured or clamped on the refrigerant output conduit 8 without the need for cutting and separating adjacent segments of the refrigerant output conduit 8. It will be recognized by those skilled in the art that the unit magnet 27 may be fixedly mounted on the refrigerant conduit 8, the condenser coil conduit 6 or any other element of the condenser coil unit 5 using any one of a variety of alternative methods. The unit magnet 27 is connected to a unit magnet wiring lead 28 which extends from the compressor housing 2 to the alarm 38, typically through the wiring conduit 37. The stationary magnet 25 is normally magnetically attached to the unit magnet 27, as illustrated in FIG. 5, to complete the alarm monitor circuit between the stationary magnet 25, the unit magnet 27 and the alarm 38. Upon attempted unauthorized removal of the condensor coil unit 5 from the compressor housing 2, the unit magnet 27 is detached from the stationary magnet 25, as illustrated in FIG. 6, since the range of movement of the stationary magnet 25 is limited by the fixed support (not illustrated) or the length of the stationary magnet wiring lead 26. Disengagement of the stationary magnet 25 from the unit magnet 27 terminates flow of current between the stationary magnet 25 and the unit magnet 27 in the alarm monitor circuit, thereby activating the alarm activation circuit in the alarm 38 and activating the alarm 38.

Referring next to FIG. 7 of the drawings, yet another embodiment the alarm system of the present invention is generally indicated by reference numeral 31 and includes an alarm clip 32, typically including a clip body 33 having a pair of adjacent clip arms 34. The clip body 33 and clip arms 34 of the alarm clip 32 are typically constructed of a flexible, electrically-insulated material such as plastic or rubber, and clip wiring leads 35 are electrically connected to respective metal contacts (not illustrated) provided on the interior faces of the respective clip arms 34. The clip wiring leads 35 extend from the compressor housing 2 and to the alarm 38 typically through a wiring conduit 37.

In application, the alarm clip 32 is attached to one of the condenser coils 12, as illustrated, or to any other suitable element of the condenser coil unit 5, by snapping the clip arms 34 around respective sides of the condenser coil 12, as illustrated. Accordingly, the metal contacts (not illustrated) on the inside surfaces of the respective clip arms 34 directly contact the condenser coil 12, and the clip arms 34 of the alarm clip 32, the condenser coil 12 of the condenser coil unit 5, and the clip wiring leads 35 form an alarm monitor circuit with the alarm 38. Under normal circumstances, current flows in a continuous path through the alarm monitor circuit, since the electrically-conductive, typically copper, aluminum or copper and aluminum condenser coil 12 completes the alarm monitor circuit and thus, prevents energizing of the alarm activation circuit inside the alarm 38. Upon partial or complete unauthorized removal of the condenser coil unit 5 from the compressor housing 2, however, the condenser coil 12 is pulled from between the clip arms 34, and this action interrupts or closes the alarm circuit between the electrical contacts (not illustrated) on the interior faces of the respective clip arms 34. Accordingly, the interrupted alarm circuit causes energizing of the alarm activation circuit, which activates the alarm 38.

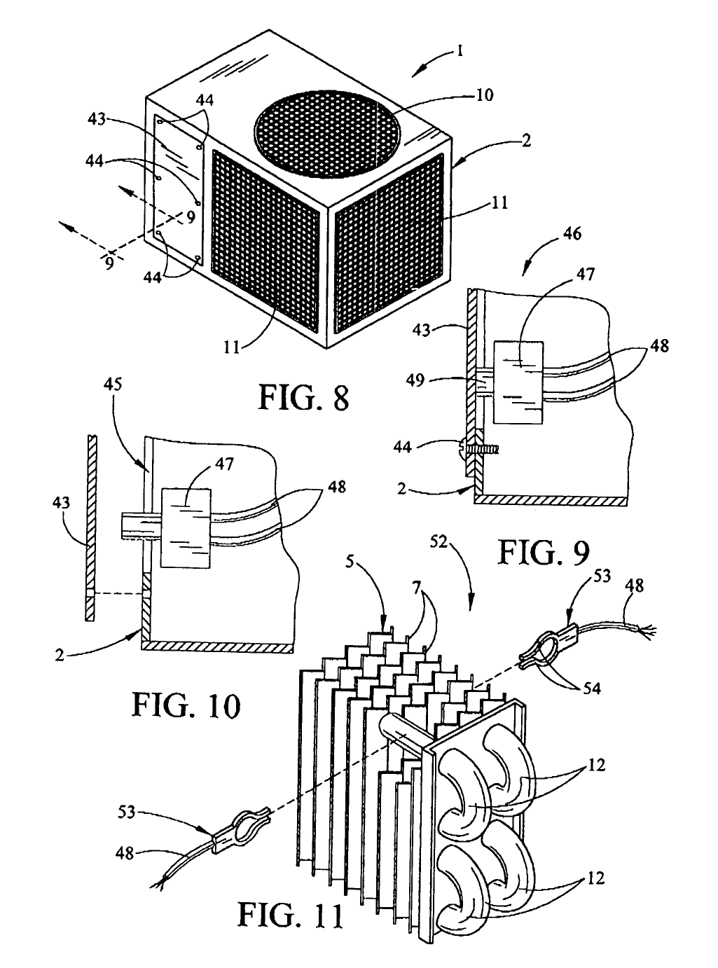

Referring next to FIGS. 8-10 of the drawings, in another embodiment the alarm system is generally indicated by reference numeral 46 and is designed to alert persons to unauthorized removal of the control panel 43 from the compressor housing 2. Accordingly, as illustrated in FIGS. 9 and 10, a switch 47, having an extendible spring-loaded button 49, is mounted in the interior of the compressor housing 2, adjacent to the control panel 43. A pair of wiring leads 48 extends from the switch 47 and forms part of an alarm monitor circuit which is connected to the alarm 38 (FIG. 1). When mounted on the compressor housing 2, the control panel 43 normally pushes the button 49 into the compressed or retracted position of FIG. 9 in the switch 47, such that the switch 47 maintains current flow through the wiring leads 48 and completes the alarm monitor circuit to the alarm 38. Upon unauthorized removal of the control panel 43 from the compressor housing 2, however, the control panel 43 disengages the spring-loaded button 49, and consequently, the button 49 extends from the switch 47, as illustrated in FIG. 10. As a result, the electrical connection between the wiring leads 48 inside the switch 47 is broken and current flow through the alarm monitor circuit is terminated, thereby activating the alarm activation circuit and the alarm 38.

While the alarm system 46 heretofore described monitors unauthorized removal of the control panel 43 from the compressor housing 2, the switch 47 may alternatively be disposed adjacent to other panels on the compressor housing 2, such as the fan screen 10 or housing screens 11, for monitoring unauthorized removal of those elements from the compressor housing 2. In that case, the fan screen 10 or housing screen or screens 11, when mounted on the compressor housing 2, would normally maintain the spring-loaded button 49 in the depressed configuration inside the switch 47, as heretofore described with respect to FIG. 9, and thus, complete the circuit between the wiring leads 48, thereby maintaining current flow through the alarm monitor circuit. Upon unauthorized removal of the fan screen 10 or housing screen or screens 11 from the compressor housing 2, the button 49 is extended from the switch 47, thereby terminating flow of current through the alarm monitor circuit and activating the alarm activation circuit and alarm 38.

Referring next to FIG. 11 of the drawings, in still another embodiment of the invention, generally indicated by reference numeral 52, the alarm system of the present invention includes a pair of conductor clips 53, each of which is typically constructed of an electrically-conductive material and includes a pair of clip arms 54. A wiring lead 48 extends from each conductor clip 53 and connects to the alarm 38 (FIG. 1) to define, in combination with the conductor clips 53 and electrically-conductive metal construction of the condenser coil unit 5, the alarm-monitoring circuit of the alarm system. Accordingly, the clip arms 54 of each conductor clip 53 typically receive one of the condenser coils 12 of the condenser coil unit 5, and current normally flows from one wiring lead 48 and conductor clip 53, through the condenser coil unit 5 and to the other wiring lead 48 and conductor clip 53, to complete the alarm monitor circuit. Upon attempted unauthorized removal of the condenser coil unit 5 from the compressor housing 2, one or both of the conductor clips 53 becomes detached from the condenser coil unit 5, and this action interrupts current flow from one conductor clip 53, through the condenser coil unit 5 and to the other conductor clip 53, thereby opening the alarm monitor circuit. Consequently, the alarm activation circuit is activated, and the alarm activation circuit, in turn, activates the alarm 38 to alert personnel to the attempted unauthorized removal of the condenser coil unit 5 from the compressor housing 2. It is understood that one of the wiring leads 48 may be connected to the condenser coil unit 5 by means of the conductor clip 53 and the other wiring lead 48 may be connected to the condenser coil unit 5 by means of soldering or any alternative fastener, according to the knowledge of those skilled in the art.

It is understood that the various embodiments described above are illustrative and that any of the features of one embodiment may be combined with any of the features of another embodiment, where applicable. For example, the tether 13 of the alarm system 14, heretofore described with respect to FIG. 3, may be soldered to the control panel 43, fan screen 10 or housing screen 11 to activate the alarm 38 upon attempted unauthorized removal of any of those elements from the compressor housing 2. Alternatively, the alarm clip 32 heretofore described with respect to the alarm system 31 of FIG. 7 may be attached to the control panel 43, the fan screen 10 or the housing screen or screens 11, according to the knowledge of those skilled in the art. Still further in the alternative, the stationary magnet 25 and the unit magnet 27 heretofore described with respect to the alarm system 24 of FIGS. 5 and 6 may be provided on the compressor housing 2 and any of the other elements such as the control panel 43, the fan screen 10 or the housing screen or screens 11, respectively.

While the preferred embodiments of the invention have been described above, it will be recognized and understood that various modifications can be made in the invention and the appended claims are intended to cover all such modifications which may fall within the spirit and scope of the invention.

Having described our invention with the particularity set forth above, we claim:

1. An alarm system for deterring theft of an article, said alarm system comprising:
an alarm;
a switch;
a circuit establishing electrical communication between said alarm and said switch;
a tether provided on said switch for connection to the article; and
wherein said tether activates said switch, said switch breaks said circuit and said alarm is activated, responsive to movement of the article and said tether.

2. The alarm system of claim 1 wherein said tether comprises a copper connector tubing.

3. The alarm system of claim 1 wherein said tether is adapted for soldering connection to the article.

4. The alarm system of claim 3 wherein said tether comprises a copper connector tubing.

5. The alarm system of claim 1 comprising a fastener provided on said tether for engaging the article.

6. The alarm system of claim 5 comprising a clamp collar for engaging the article and wherein said fastener comprises a self-tapping screw engaging said clamp collar.

7. The alarm system of claim 5 wherein said tether comprises a copper connector tubing.

8. An alarm system for deterring theft of an article, said alarm system comprising:
an alarm;
a circuit electrically connected to said alarm;
an attachment mechanism provided in said circuit for removably engaging the article; and
wherein said circuit is opened and said alarm is activated responsive to disengagement of said attachment mechanism from the article.

9. The system of claim 8 wherein said attachment mechanism comprises an alarm clip.

10. The system of claim 8 comprising a first magnet provided in said circuit for mounting on the article and wherein said attachment mechanism comprises a second magnet provided in said circuit for removably engaging said first magnet and normally establishing electrical communication between said first magnet and said second magnet.

11. The system of claim 8 wherein said attachment mechanism comprises a pair of conductor clips for engaging the article.

12. A method for deterring theft of a condenser coil unit from an air conditioner compressor unit, said method comprising:
providing an alarm;
providing a circuit in electrical communication with said alarm;
providing a switch in said circuit;
connecting said switch to said condenser coil unit;
sending a current through said circuit; and
terminating flow of said current through said circuit and activating said alarm by triggering said switch, responsive to movement of said condenser coil unit with respect to said switch.

13. The method of claim 12 comprising providing a tether and connecting said switch to said condenser coil unit by means of said tether.

14. The method of claim 13 wherein said tether comprises a copper connector tubing.

15. The method of claim 14 comprising soldering said copper connector tubing to said condenser coil unit.

16. The method of claim 13 comprising providing a fastener and connecting said tether to said condenser coil unit by means of said fastener.

17. The method of claim 16 wherein said tether comprises a copper connector tubing.

18. The method of claim 16 comprising providing a clamp collar on said condenser coil unit and wherein said fastener comprises a self-tapping screw and said connecting said tether to said condenser coil unit by means of said fastener comprises connecting said tether to said clamp collar by means of said self-tapping screw.

19. The method of claim 18 wherein said tether comprises a copper connector tubing.

20. A method for deterring theft of a condenser coil unit from an air conditioner compressor unit, said method comprising:
providing an alarm;
providing a circuit in electrical communication with said alarm;
providing a first magnet in said circuit and mounting said first magnet on said condenser coil unit;
providing a second magnet in said circuit and removably and electrically attaching said second magnet to said first magnet by magnetic attraction;
sending a current through said circuit; and
terminating flow of said current through said circuit and activating said alarm by disengaging said first magnet from said second magnet, responsive to pulling said condenser coil unit and said first magnet away from said second magnet.

21. A method for deterring theft of a condenser coil unit from an air conditioner compressor unit, said method comprising:
providing an alarm;
providing a circuit in electrical communication with said alarm;
providing an alarm clip in said circuit;
establishing electrical communication between said condenser coil unit and said circuit by connecting said alarm clip to said condenser coil unit;
sending a current through said circuit; and
terminating flow of said current through said circuit and activating said alarm by disengaging said alarm clip from said condenser coil unit, responsive to pulling said condenser coil unit against said alarm clip.

22. An alarm system for deterring theft of an article, said alarm system comprising:
an alarm;
a switch;
a circuit establishing electrical communication between said alarm and said switch;
a spring-loaded button extendible from said switch; and
wherein said spring-loaded button activates said switch, said switch breaks said circuit and said alarm is activated, responsive to extension of said spring-loaded button from said switch.

23. A method for deterring removal of a panel from an air conditioner compressor unit, said method comprising:
providing an alarm;
providing a circuit in electrical communication with said alarm;
providing a switch in said circuit;
providing a spring-loaded button in said switch, said button capable of a depressed configuration in said switch wherein said button closes said circuit and said button capable of an extended configuration from said switch wherein said button opens said circuit;
maintaining said button in said depressed configuration in said switch when said panel is mounted on the unit;
sending a current through said circuit; and
terminating flow of said current through said circuit and activating said alarm by extending said button from said switch, responsive to removing said panel from said unit.

24. The method of claim 23 wherein said panel comprises a control panel.

25. The method of claim 23 wherein said panel comprises a fan screen.

26. The method of claim 23 wherein said panel comprises a housing screen.

27. A method for deterring theft of a condenser coil unit from an air conditioner compressor unit, said method comprising:
providing an alarm;
providing a circuit in electrical communication with said alarm;
providing at least one conductor clip in said circuit;
establishing electrical communication between said condenser coil unit and said circuit by connecting said at least one conductor clip to said condenser coil unit;
sending a current through said circuit; and
terminating flow of said current through said circuit and activating said alarm by disengaging said at least one conductor clip from said condenser coil unit, responsive to pulling said condenser coil unit against said at least one conductor clip.

28. The method of claim 27 wherein said at least one conductor clip comprises two conductor clips.
